(19) United States
(12) Patent Application Publication
(10) Pub. No.: US 2026/0331753 A1
(43) Pub. Date: Oct. 22, 2026

(54) BASE STATION ANTENNAS HAVING COMPACT WIDEBAND CLOAKING RADIATING ELEMENTS

(71) Applicant: Outdoor Wireless Networks LLC, Richardson, TX (US)

(72) Inventors: Uparnabh Ghoshal, Margao GOA (IN); Rashmi Borah, Tezpur (IN); Kumara Swamy Kasani, GodavariKahani (IN)

(21) Appl. No.: 19/529,365

(22) Filed: Feb. 4, 2026

(30) Foreign Application Priority Data
Feb. 10, 2025 (IN) 202541011003

(51) Int. Cl. H01Q 1/24; H01Q 5/30; H01Q 9/16; H01Q 19/10

(52) U.S. Cl. CPC H01Q 1/246; H01Q 5/30; H01Q 9/16; H01Q 19/10

(57) ABSTRACT

Antennas include a reflector and first and second radiating element that extend forwardly from the reflector. The first and second radiating elements are configured to operate in respective first and second operating frequency bands, where the second operating frequency band that encompasses higher frequencies. The first radiating element includes a first dipole radiator having first and second dipole arms, and a second dipole radiator having third and fourth dipole arms. The first dipole arm comprises a first resonant circuit that includes a first inner metal patch and a first upper metal ring section that at least partially surrounds the first inner metal patch and a second resonant circuit that includes a second inner metal patch and a second upper metal ring section that at least partially surrounds the second inner metal patch. A perimeter of the first inner metal patch exceeds a perimeter of the second inner metal patch.

### CROSS-REFERENCE TO RELATED APPLICATION

The present application claims priority under 35 U.S.C. § 119 to Indian Provisional Patent Application Serial No. 202541011003, filed Feb. 10, 2025, the entire content of which is incorporated herein by reference.

### BACKGROUND

The present invention generally relates to radio communications and, more particularly, to base station antennas for cellular communications systems.

Cellular communications systems are known in the art. In a cellular communications system, a geographic area is divided into a series of regions that are referred to as “cells” which are served by respective macro cell base stations. Each macro cell base station includes one or more antennas that are configured to provide two-way radio frequency (“RF”) communications with mobile subscribers that are within the cell served by the base station. In one common configuration, the coverage area of a cellular communication system is divided into a plurality of hexagonally-shaped regions or “sectors” that each span an arc of 120° in the azimuth plane, and each macro cell base station includes three base station antennas that provide service to respective ones of the hexagonally-shaped sectors. Each base station antenna may include one or more “linear” phased arrays of radiating elements, where each linear array is a column (or staggered column) of radiating elements that is configured to generate radiation patterns (also referred to herein as “antenna beams”) that cover the entire 120° sector. The base station antennas may also include multi-column arrays of radiating elements that are connected to beamforming radios. The beamforming radios actively adjust the phases of the sub-components of the RF signals that are fed to individual groups of the radiating elements so that the multi-column arrays generate narrower, higher gain antenna beams that can be electronically steered throughout the sector. Modern cellular communications systems also commonly include small cell base stations that are implemented within each macro cell that provide additional capacity for portions of the macro cell that have high traffic volumes.

In order to accommodate the increasing volume of cellular communications, cellular operators have added cellular service in a variety of new frequency bands. While in some cases it is possible to use a single array of so-called “wide-band” or “ultra-wide-band” radiating elements to provide service in multiple frequency bands, in other cases it is necessary to use different arrays of radiating elements to support service in the different frequency bands. Accordingly, most macro cells employ multi-band base station antennas that include arrays of radiating elements that operate in different operating frequency bands. For example, base station antennas are now being deployed that include two linear arrays of “low-band” radiating elements that operate in some or all of the 694-960 MHz frequency range, and two or four linear arrays of “mid-band” radiating elements that operate in some or all of the 1427-2690 MHz frequency range. Base station antennas are also widely being deployed that include low-band arrays (i.e., arrays of low-band radiating elements), mid-band arrays (i.e., arrays of mid-band radiating elements), and one or more multi-column beamforming arrays of high-band radiating elements that operate in some, for example, or all of the 3.1-4.2 GHz frequency band. The low-band, mid-band and high-band arrays are typically located in close proximity to each other in order to reduce the width of the base station antenna. Unfortunately, the radiating elements of a first array may cause “scattering” of the antenna beams of other closely positioned arrays, which may distort the radiation patterns of the closely positioned arrays so that the gain and coverage of the closely positioned arrays are degraded.

### SUMMARY

Pursuant to embodiments of the present invention, antennas (e.g., a base station antenna) are provided that include a reflector, first and second radiating element that extend forwardly from the reflector. The first radiating element is configured to operate in a first operating frequency band and the second radiating element is configured to operate in a second operating frequency band that encompasses higher frequencies than the first operating frequency band. The first radiating element includes a first dipole radiator having a first dipole arm and a second dipole arm, and a second dipole radiator having a third dipole arm and a fourth dipole arm. The first dipole arm comprises a first resonant circuit that includes a first inner metal patch and a first upper metal ring section that at least partially surrounds the first inner metal patch and a second resonant circuit that includes a second inner metal patch and a second upper metal ring section that at least partially surrounds the second inner metal patch. Moreover, a perimeter of the first inner metal patch is greater than a perimeter of the second inner metal patch.

In some embodiments, the first and second resonant circuits are a first and second of the resonant circuits, respectively, of a plurality of resonant circuits. The resonant circuits in the plurality of resonant circuits may be electrically connected to each other in series. The first of the resonant circuits may be the one of the plurality of resonant circuits that is closest to the second dipole arm. The second of the resonant circuits is the one of the plurality of resonant circuits that is farthest from the second dipole arm. The first of the resonant circuits may be physically and electrically connected to a third of the resonant circuits by a first meandered metal trace. The second of the resonant circuit may be physically and electrically connected to a fourth of the resonant circuits by a second meandered metal trace.

In some embodiments, each resonant circuit in the plurality of resonant circuits may be physically and electrically connected to at least one other of the resonant circuits in the plurality of resonant circuits by a respective meandered metal trace. The first dipole arm may extend along a longitudinal axis, and a first of the meandered metal traces may extend to a first side of the longitudinal axis, and a second of the meandered metal traces may extend to a second side of the longitudinal axis that is opposite the first side. In some embodiments, a third of the meandered metal traces may extend to the first side of the longitudinal axis, and the second of the meandered metal traces is in between the first and third of the meandered metal traces. In some embodiments, the plurality of resonant circuits and the plurality of meandered metal traces may all be implemented in a single metal layer of a printed circuit board.

In some embodiments, the first resonant circuit may further comprise a first lower metal ring section that at least partially surrounds the first inner metal patch. In some embodiments, the first upper metal ring section and the first lower metal ring section may each surround at least 25% and less than 50% of the perimeter of the first inner metal patch. In some embodiments, the second resonant circuit may further comprise a second lower metal ring section that at least partially surrounds the second inner metal patch.

In some embodiments, the first upper metal ring section may be physically and electrically connected to the first inner metal patch by a first upper metal bridge that extends from the first inner metal patch to the first upper metal ring section, the second upper metal ring section may be physically and electrically connected to the second inner metal patch by a second upper metal bridge that extends from the second inner metal patch to the second upper metal ring section, the first lower metal ring section may be physically and electrically connected to the first inner metal patch by a first upper metal bridge that extends from the first inner metal patch to the first lower metal ring section, and the second lower metal ring section may be physically and electrically connected to the second inner metal patch by a second lower metal bridge that extends from the second inner metal patch to the second lower metal ring section.

In some embodiments, the first upper metal bridge and the first lower metal bridge may extend radially from the first inner metal patch at respective first and second angles, and the second upper metal bridge and the second lower metal bridge may extend radially from the second inner metal patch at respective third and fourth angles, where the first angle may be different than both the third angle and the fourth angle. In some embodiments, the second angle may also be different than both the third angle and the fourth angle.

In some embodiments, the first inner metal patch and the second inner metal patch may have circular perimeters and the first upper metal ring section and the second upper metal ring section may be arcuate metal ring sections. In other embodiments, the first inner metal patch and the second inner metal patch may have rectangular perimeters and the first and second upper metal ring sections may be rectangular metal ring sections.

In some embodiments, the first resonant circuit may be a first parallel inductor-capacitor (“LC”) circuit and the second resonant circuit may be a second parallel LC circuit.

In some embodiments, the first and second dipole arms may be configured to be substantially transparent to RF signals in the second operating frequency band. In some embodiments, the antenna may further comprise a third radiating element extending forwardly from the reflector that is configured to operate in a third operating frequency band that encompasses higher frequencies than the second operating frequency band. In such embodiments, the first and second dipole arms may be configured to also be substantially transparent to RF signals in the third operating frequency band.

Pursuant to further embodiments of the present invention, antennas are provided that comprise a reflector, first and second radiating element that extend forwardly from the reflector. The first radiating elements configured to operate in a first operating frequency band and the second radiating element is configured to operate in a second operating frequency band that encompasses higher frequencies than the first operating frequency band. The first radiating element includes a first dipole radiator having a first dipole arm and a second dipole arm and a second dipole radiator having a third dipole arm and a fourth dipole arm. The first dipole arm comprises a first resonant circuit that includes a first inner metal patch, a first upper metal ring section and a first lower metal ring section that each partially surround the first inner metal patch, and a first upper metal bridge and a first lower metal bridge that extend radially from the first inner metal patch to the first upper metal ring section and the first lower metal ring section at respective first and second angles. The first dipole arm comprises a second resonant circuit that includes a second inner metal patch, a second upper metal ring section and a second lower metal ring section that each partially surround the second inner metal patch, and a second upper metal bridge and a second lower metal bridge that extend radially from the second inner metal patch to the second upper metal ring section and the second lower metal ring section, respectively, at respective third and fourth angles. The first angle is different than both the third angle and the fourth angle.

Pursuant to additional embodiments of the present invention, antennas are provided that comprise a reflector, first and second radiating element that extend forwardly from the reflector. The first radiating elements configured to operate in a first operating frequency band and the second radiating element is configured to operate in a second operating frequency band that encompasses higher frequencies than the first operating frequency band. The first radiating element includes a first dipole radiator having a first dipole arm and a second dipole arm and a second dipole radiator having a third dipole arm and a fourth dipole arm. The first dipole arm comprises a plurality of parallel inductor-capacitor (“LC”) resonant circuits that are electrically connected to each other in series by a plurality of meandered metal traces, where each resonant circuit in the plurality of parallel LC resonant circuits comprises an inner metal patch and at least one metal ring section that at least partially surrounds the respective inner metal patch.

Pursuant to further embodiments of the present invention, antennas are provided that comprise a reflector, first and second radiating element that extend forwardly from the reflector. The first radiating elements configured to operate in a first operating frequency band and the second radiating element is configured to operate in a second operating frequency band that encompasses higher frequencies than the first operating frequency band. The first radiating element includes a first dipole radiator having a first dipole arm and a second dipole arm and a second dipole radiator having a third dipole arm and a fourth dipole arm. The first dipole arm comprises a first resonant circuit that includes a first inner metal patch and a first upper metal ring section and a first lower metal ring section that are on opposed sides of the first inner metal patch and that partially surround the first inner metal patch. The second dipole arm comprises a second resonant circuit that includes a second inner metal patch and a second upper metal ring section and a second lower metal ring section that are on opposed sides of the second inner metal patch and that partially surround the second inner metal patch. A first length of the first upper metal ring section is different than a third length of the second upper metal ring section and different than a fourth length of the second lower metal ring section.

### BRIEF DESCRIPTION OF THE DRAWINGS

FIG. 1 is a perspective view of a base station antenna according to embodiments of the present invention.

FIG. 2 is a schematic front view of the base station antenna of FIG. 1 with the radome removed.

FIGS. 3A and 3B are a schematic perspective view and a schematic front view, respectively, of one of the low-band radiating elements of the base station antenna of FIGS. 1-2.

FIG. 3C is an enlarged front view of one of the two dipole radiators included in the low-band radiating element of FIGS. 3A-3B.

FIG. 3D is a circuit diagram illustrating the equivalent circuit of one of the dipole arms of the low-band radiating element of FIGS. 3A-3B.

FIG. 4 is a front view of a radiating element according to further embodiments of the present invention.

FIGS. 5A-5D are plan views of dipole radiators of radiating element according to additional embodiments of the present invention.

FIG. 6 is a front view of a dipole radiator of a radiating element according to still further embodiments of the present invention.

### DETAILED DESCRIPTION

Embodiments of the present invention relate generally to radiating elements for multi-band base station antennas and to related base station antennas. The multi-band base station antennas according to embodiments of the present invention may, for example, support two, three or more major air-interface standards in two, three or more cellular frequency bands.

A challenge in the design of multi-band base station antennas is reducing the effect of scattering of the RF signals at one frequency band by the radiating elements of other frequency bands. Scattering is undesirable as it may negatively impact the shape of the antenna beam in both the azimuth and elevation planes. For example, in the azimuth plane, scattering can impact the beamwidth, beam shape, pointing angle, gain and front-to-back ratio, typically in undesirable ways. Moreover, the impact of scattering may vary significantly with frequency, which may make it hard to compensate. The radiating elements according to certain embodiments of the present invention may be designed to have reduced impact on the antenna patterns of closely located radiating elements that transmit and receive signals in other frequency bands (i.e., reduced scattering). Importantly, the radiating elements may exhibit reduced scattering over large bandwidths. Radiating elements that exhibit reduced scattering in the operating frequency bands of nearby radiating elements may be referred to herein as “cloaking” radiating elements.

Cloaking radiating elements are known in the art. For example, U.S. Pat. No. 9,570,804 discloses a low-band radiating element that operates in the 696-960 MHz frequency band that includes dipole arms that are formed as a series of RF chokes in order to render the radiating element substantially transparent to RF energy in the 1.7-2.7 GHz frequency band. U.S. Pat. Nos. 10,439,285 and 10,770,803 each disclose radiating elements that operate in the 696-960 MHz frequency band that include dipole arms that are formed as a series of widened segments that are coupled by narrow inductive segments, which may be implemented as small meandered trace segments on a printed circuit board. In each case, the narrow inductive segments act as high impedance elements for RF energy in the 1.7-2.7 GHz frequency band, rendering the radiating elements substantially transparent to RF energy in that frequency range. As another example, U.S. Pat. No. 11,018,437 discloses a radiating element that operates in the 696-960 MHz frequency band that includes two dipole arms that are substantially transparent to RF energy in the 1.7-2.7 GHz frequency band and another two dipole arms that are substantially transparent to RF energy in the 3.3-4.2 GHz frequency band. Additional cloaking radiating element designs are disclosed in Chinese Patent No. CN 112787061A, Chinese Patent No. CN 112164869A, Chinese Patent No. CN 112290199A, Chinese Patent No. CN 111555030A, Chinese Patent No. CN 112186333A, Chinese Patent No. CN 112186341A, Chinese Patent No. CN 112768895A, Chinese Patent No. CN 112821044A, Chinese Patent No. CN 213304351U, and Chinese Patent No. CN 112421219A. PCT Publication WO 2023/167784 discloses cloaking radiating elements that are formed as a plurality of split ring resonators or complementary split ring resonators that are electrically coupled in series. U.S. Pat. No. 12,051,855 discloses cloaking radiating elements that include stacked meandered conductive paths that are cloaked over portions of both the mid-band and high-band frequency ranges.

Many known cloaking low-band radiating elements are only designed to be substantially transparent in one of the mid-band or high-band operating frequency ranges. Moreover, cloaking low-band radiating elements that provide cloaking in portions of both the mid-band and high-band frequency ranges tend to have relatively poor cloaking performance in portions of the desired cloaking frequency range. Additionally, many existing cloaking low-band radiating elements tend to be relatively large, which may result in poor isolation performance in antennas that include multiple arrays of such low-band radiating elements.

Pursuant to embodiments of the present invention, multi-band base station antennas are provided that have at least one or more arrays of first radiating elements that transmit and receive signals in a first frequency operating band and one or more arrays of second radiating elements that transmit and receive signals in a second, different operating frequency band that encompasses higher frequencies. These antennas may also include one or more arrays of third radiating elements that transmit and receive signals in a third frequency operating band. In some embodiments, the first, second and third frequency operating frequency bands may not include any overlapping frequency ranges. For example, the first operating frequency band may be some or all of the 617-960 MHz low-band frequency range, the second operating frequency band may be some or all of the 1427-2960 MHz mid-band frequency range, and the third operating frequency band may be some or all the 3.1-4.2 GHz high-band frequency range. Each first radiating element may be a wideband cloaking radiating element that has first and second dipole radiators that are substantially transparent to RF energy in the second operating frequency band and the third operating frequency band. The first and second dipole radiators may each be center fed and implemented in a “cross” arrangement so that the first and second dipole radiators transmit and receive RF signals at respective slant −45° and +45° linear polarizations.

Each dipole radiator may comprise a pair of dipole arms, and each dipole arm may include a plurality of resonant circuit nodes. Each resonant circuit node may comprise, for example, a parallel inductor-capacitor (“LC”) circuit. Each resonant circuit node may be implemented as an inner metal patch, at least one metal ring section that at least partially surrounds the inner metal patch and that is separated from the inner metal patch by a gap, and at least one metal bridge that crosses the gap to physically and electrically connect the inner metal patch to the metal ring section. In example embodiments, the inner metal patches may have circular or rectangular shapes. The resonant circuit nodes may be electrically connected to each other in series by a plurality of connecting metal traces. In some embodiments, each connecting metal trace may be a meandered metal trace. The meandered metal traces may have a relatively high inductance and may be meandered so that segments of each meandered metal trace capacitively couple with each other. Thus, the meandered metal traces may form additional resonant circuits that electrically connect the resonant circuit nodes to each other in series. Using meandered conductive traces to connect each pair of adjacent first resonant circuits may improve both the impedance matching and cloaking performance of the dipole arms.

The inner metal patch of at least one of the resonant circuit nodes may be larger than the inner metal patch of at least one other of the resonant circuit nodes. For example, the resonant circuit node that is closest to a feed point of the center-fed first dipole arm may have an inner metal patch that is larger than the inner metal patch of at least one other of the resonant circuit nodes included in the first dipole arm. Such a design may improve the cloaking performance of the dipole arm (and hence improves the cloaking performance of a radiating element that includes a plurality of such dipole arms). The resonant circuit node that has the larger inner metal patch may improve the cloaking performance at lower frequencies of a frequency range that is to be cloaked, and the resonant circuit node that has the smaller inner metal patch may improve the cloaking performance at higher frequencies of a frequency range that is to be cloaked. Varying the sizes (and hence the perimeters) of the inner conductive patches may significantly improve the cloaking performance of the radiating element.

Cloaking radiating elements are, generally speaking, more difficult to impedance match over a wide bandwidth. In some jurisdictions, the low-band operating frequency range extends from 617-960 MHz, which is a very wide bandwidth. It may be particularly difficult to obtain a good impedance match between the feed stalk and the innermost resonant circuit node of each dipole arm (which is the resonant circuit node that is directly fed by feed stalk). To improve the impedance match between the innermost resonant circuit node of each dipole arm and the feed stalks, the positions of the metal bridge(s) that connect the inner metal patch to the metal ring section(s) of the innermost resonant circuit node may differ from the positions of the metal bridge(s) of other of the resonant circuit nodes. Additionally or alternatively, the range of angles sub-tended by the metal ring section(s) of the innermost resonant circuit node may differ from the range of angles sub-tended by the metal ring section(s) of other of the resonant circuit nodes.

In some embodiments, the resonant frequency of one or more of the resonant circuit nodes may be within the second operating frequency band and the resonant frequency of other of the resonant circuit nodes may be within the third operating frequency band. This approach may broaden the frequency range over which the dipole arm is substantially transparent or “cloaking” so that the dipole arm can be configured to be cloaking over the frequencies within both the second and third operating frequency bands. This may be important if the low-band radiating elements are positioned adjacent both mid-band and high-band radiating elements.

Embodiments of the present invention will now be described in further detail with reference to the attached figures.

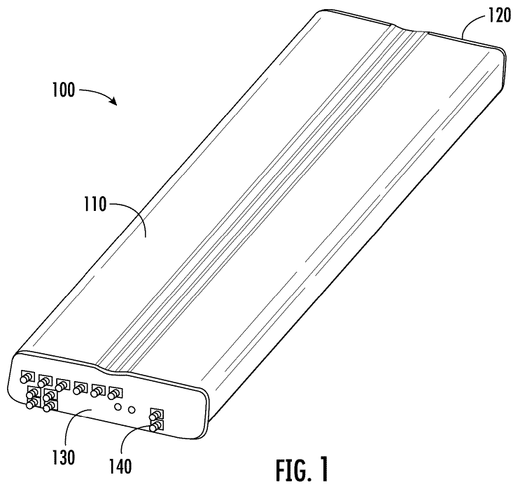

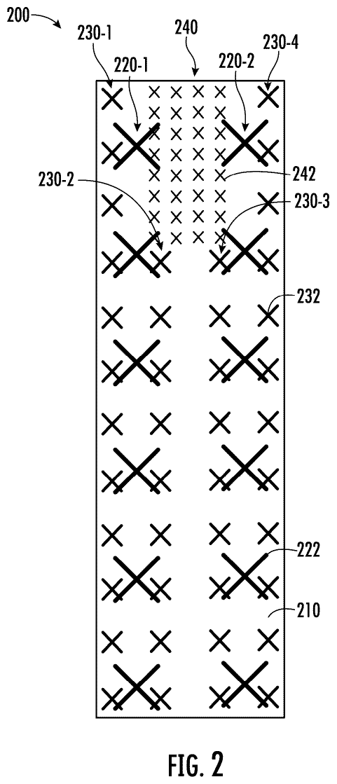

FIGS. 1 and 2 illustrate a base station antenna 100 according to certain embodiments of the present invention. In particular, FIG. 1 is a perspective view of the antenna 100, while FIG. 2 is a front view of the antenna 100 with the radome thereof removed to illustrate the antenna assembly 200 of the antenna 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

As shown in FIGS. 1-2, the base station antenna 100 is an elongated structure that has a tubular shape with a generally rectangular cross-section. The antenna 100 includes a radome 110 and a top end cap 120. The antenna 100 also includes a bottom end cap 130 which includes a plurality of connectors 140 such as RF ports mounted therein. The antenna 100 is typically mounted in a vertical configuration (i.e., the longitudinal axis of the antenna 100 may be generally perpendicular to a plane defined by the horizon) when the antenna 100 is mounted for normal operation. The radome 110, top cap 120 and bottom cap 130 may form an external housing for the antenna 100. An antenna assembly 200 is contained within the external housing.

FIG. 2 is a front view of the antenna assembly 200 of base station antenna 100. As shown in FIG. 2, the antenna assembly 200 includes a reflector 210 and a plurality of radiating elements 222, 232, 242. Various mechanical and electronic components (not shown) may be mounted behind the reflector 210 such as, for example, phase shifters, remote electronic tilt units, mechanical linkages, controllers, diplexers, and the like. The reflector 210 may comprise or include a metallic surface (e.g., a sheet of aluminium) that reflects RF energy that is emitted backwardly by the radiating elements 222, 232, 242 in the forward direction, and may also serve as a ground plane for the radiating elements 222, 232, 242.

Each radiating element 222, 232, 242 may be a dual-polarized radiating element. In the depicted embodiment, each radiating element 222, 232, 242 is implemented as a so-called cross-dipole radiating element that includes first and second dipole radiators that are configured to transmit and receive RF signals having slant −45° and +45° linear polarizations, respectively. The radiating elements 222, 232, 242 are mounted to extend forwardly from the reflector 210.

The radiating elements include low-band radiating elements 222, mid-band radiating elements 232 and high-band radiating elements 242. The low-band radiating elements 222 are mounted in two columns to form two linear arrays 220-1, 220-2 of low-band radiating elements 222. The mid-band radiating elements 232 are mounted in four columns to form four linear arrays 230-1 through 230-4 of mid-band radiating elements 232. The high-band radiating elements 242 are mounted in four closely spaced columns to operate as a multi-column beamforming array of high-band radiating elements 242. It will be appreciated that the number of arrays of radiating elements may be varied from what is shown in FIG. 2, as may the number of radiating elements in each array, and the relative positions of the arrays. It should be noted that herein like elements may be referred to individually by their full reference numeral (e.g., linear array 230-2) and may be referred to collectively by the first part of their reference numeral (e.g., the linear arrays 230).

The low-band radiating elements 222 may be configured to transmit and receive signals in the 617-960 MHz frequency range or a portion thereof (e.g., the 617-896 MHz frequency band, the 696-960 MHz frequency band, etc.). The mid-band radiating elements 232 may be configured to transmit and receive signals in the 1427-2690 MHz frequency range or a portion thereof (e.g., the 1710-2200 MHz frequency band, the 1695-2690 MHz frequency band, etc.). The high-band radiating elements 242 may be configured to transmit and receive signals in the 3.1-4.2 GHz frequency range or a portion thereof (e.g., the 3.3-4.0 GHz frequency band).

As noted above, the radiating elements 222, 232, 242 may be dual polarized radiating elements, and hence each array 220, 230, 240 may be used to form a pair of antenna beams, namely an antenna beam for each of the two polarizations at which the dual-polarized radiating elements are designed to transmit and receive RF signals. While not shown in FIG. 2, the radiating elements 222, 232, 242 may be mounted on feed boards that couple RF signals to and from the individual radiating elements 222, 232, 242. One or more radiating elements 222, 232, 242 may be mounted on each feed board. Cables or other structures may be used to connect each feed board to other components of the antenna such as diplexers, phase shifters or the like. As can be seen in FIG. 2, some of the low-band radiating elements 222 are in close proximity to one or more mid-band radiating elements 232 and to one or more high-band radiating elements 242.

Cellular network operators are interested in deploying antennas that have a large number of arrays of radiating elements in order to reduce the number of base station antennas required per base station. However, increasing the number of arrays typically increases the width of the antenna. Both the weight and wind loading of a base station antenna increase with increasing width, and thus wider base station antennas tend to require more robust antenna mounts and antenna towers, both of which can significantly increase the cost of a base station. Accordingly, cellular network operators may place limitations on the widths of base station antennas (where the limits may depend on the application for the antenna).

The width of a multi-band base station antenna may be reduced by decreasing the separation between adjacent arrays of radiating elements included in the antenna. However, as the separation is reduced, increased coupling between the radiating elements of the different arrays occurs, and this increased coupling may impact the shapes of the antenna beams generated by the arrays in undesirable ways. For example, a low-band cross-dipole radiating element will typically have dipole radiators that have an electrical length that is approximately ½ a wavelength of the center frequency of the designed operating frequency band for the radiating element. Each dipole radiator has two dipole arms, and hence each dipole arm has an electrical length that is approximately ¼ a wavelength of the center frequency of the designed operating frequency band. If the low-band radiating element is designed to operate in the 696-960 MHz frequency band and the mid-band radiating element is designed to operate in the 1427-2690 MHz frequency band, each dipole arm of the low-band radiating element radiator will have a length that is ½ a wavelength of a frequency within the operating frequency band of the mid-band radiating element, and hence RF energy transmitted by the mid-band radiating elements will tend to couple to the low-band radiating elements since such RF energy will be resonant in a ½ wavelength dipole arm. Similarly, if the high-band radiating element is designed to operate in the 3.1-4.2 GHz frequency band, each dipole arm of the low-band radiating element radiator will have a length that is a wavelength of a frequency within the operating frequency band of the mid-band radiating element, and hence RF energy transmitted by the high-band radiating elements will tend to couple to the low-band radiating elements since such RF energy will be resonant on the low-band dipole arms.

When mid-band or high-band RF energy couples to the dipole arms of a low-band radiating element, mid-band or high-band RF currents are induced on the low-band dipole arms. The induced RF currents generate mid-band or high-band RF radiation that is emitted from the low-band dipole arms. The mid-band or high-band RF energy emitted from the dipole arms of the low-band radiating element distorts the antenna beam of the mid-band or high-band arrays since the radiation is being emitted from a different location than intended. The greater the extent that mid-band or high-band RF currents are induced on the low-band dipole arms, the greater the impact on the characteristics of the antenna beams generated by the mid-band or high-band arrays.

The low-band radiating elements 222 according to some embodiments of the present invention may be designed to be substantially transparent to RF energy emitted by both the mid-band radiating elements 232 and the high-band radiating elements 242. As such, even if the mid-band and/or high-band radiating elements 232, 242 are in close proximity to the low-band radiating elements 222, the above-discussed undesired coupling of higher-band RF energy onto the low-band radiating elements 222 may be significantly reduced. Moreover, the low-band radiating elements 222 are not only transparent to RF energy over a very wide bandwidth, but they also have good return loss performance over the full low-band operating frequency range.

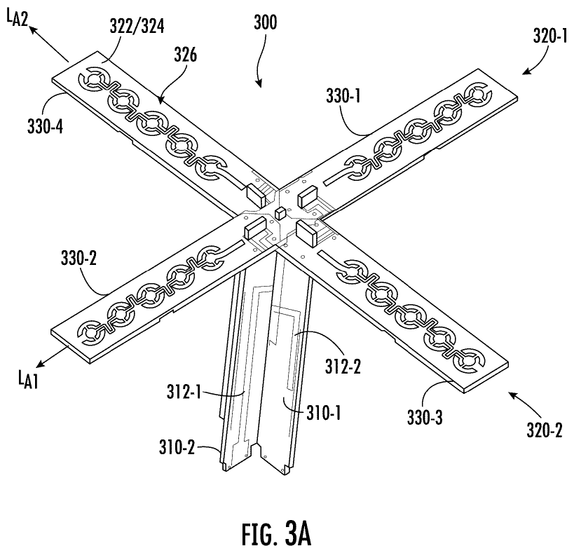

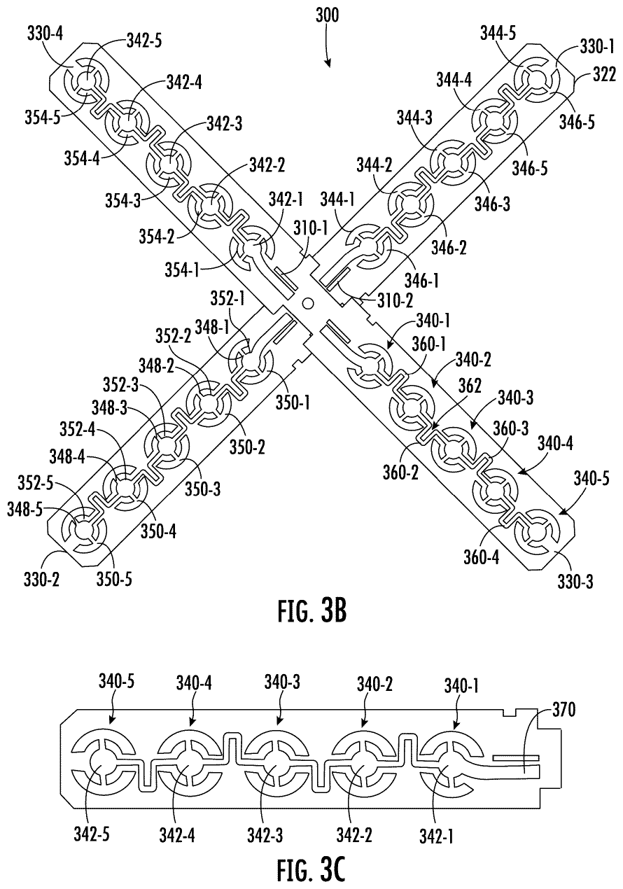

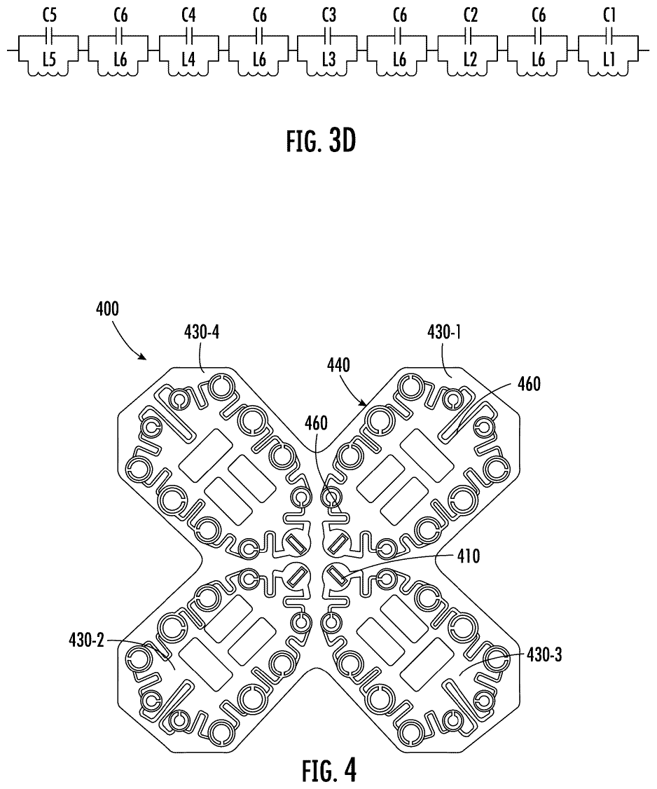

FIGS. 3A-3C illustrate a low-band radiating element 300 according to embodiments of the present invention that may be used to implement the low-band radiating elements 222 of base station antenna 100. In particular, FIGS. 3A and 3B are schematic perspective and front views, respectively, of the low-band radiating element 300, and FIG. 3C is an enlarged front view of one of the dipole arms included in the low-band radiating element 300 of FIGS. 3A-3B.

As shown in FIG. 3A, the low-band radiating element 300 includes first and second feed stalks 310-1, 310-2, and a dipole radiator printed circuit board 322. The dipole radiator printed circuit board 322 may comprise a single printed circuit board or may comprise multiple printed circuit boards. First and second dipole radiators 320-1, 320-2 are formed on the dipole radiator printed circuit board 322. The first dipole radiator 320-1 includes first and second dipole arms 330-1, 330-2, and the second dipole radiator 320-2 includes third and fourth dipole arms 330-3, 330-4. The dipole radiators 320-1, 320-2 may be implemented in a “cross” arrangement to form a pair of center-fed slant +/−45° dipole radiators 320.

The feed stalks 310-1, 310-2 may each comprise a printed circuit board that have respective RF transmission lines 312-1, 312-2 formed thereon. These RF transmission lines 312 carry RF signals between a feed board (not shown) that is mounted on the reflector 210 and the dipole radiators 320. The RF transmission lines 312 on the respective feed stalks 310 may center feed the dipole radiators 320-1, 320-2, meaning that RF signals are coupled from the feed stalks 310 to the base of each dipole arm 330 (i.e., the portion of the dipole arm 330 closest to the center of the radiating element 300).

The dipole radiator printed circuit board 322 includes a dielectric substrate 324 that has a conductive layer 326 formed on a first side thereof. The conductive layer 324 may comprise a patterned copper layer in example embodiments which may be referred to herein as a “metal layer.” The dipole radiator printed circuit board 322 may also include a protective dielectric coating (not shown) that covers and protects the metal layer 326. The metal layer 326 may form each dipole arm 330.

The first dipole radiator 320-1 extends along a first axis L_{A1} and the second dipole radiator 320-2 extends along a second axis L_{A2} that is generally perpendicular to the first axis L_{A1}. Consequently, the first and second dipole radiators 320-1, 320-2 are arranged in the general shape of a cross. Dipole arms 330-1 and 330-2 of first dipole radiator 320-1 are center fed by the first RF transmission line 312-1 and radiate together at a first polarization. In the depicted embodiment, the first dipole radiator 320-1 is designed to transmit signals having a +45° polarization. Dipole arms 330-3 and 330-4 of second dipole radiator 320-2 are center fed by a second RF transmission line 312-2 and radiate together at a second polarization that is orthogonal to the first polarization. The second dipole radiator 320-2 is designed to transmit signals having a −45° polarization.

Referring again to FIG. 2, the low-band radiating elements 222 (300) extend farther forwardly from the reflector 210 than do the mid-band and high-band radiating elements 232, 242. In order to keep the width of the base station antenna 100 relatively narrow, some of the low-band radiating elements 222 (300) may overlap various of the mid-band and/or high-band radiating elements 232, 242 in the forward direction so that the mid-band and/or high-band radiating elements 232, 242 are positioned directly behind the dipole arms of the low-band radiating elements. While positioning the low-band radiating elements 222 (300) so that they overlap the mid-band and/or high-band radiating elements 232, 242 may advantageously facilitate reducing the width of the base station antenna 100, this approach may significantly increase the coupling of RF energy transmitted by the mid-band and/or high-band radiating elements 232, 242 onto the low-band radiating elements 222 (300), and such coupling may degrade the antenna beams formed by the arrays 230, 240 of mid-band and/or high-band radiating elements 232, 242.

In order to reduce such coupling, the low-band radiating elements 300 may be designed to have dipole arms 330 that are substantially “transparent” to radiation emitted by both the mid-band radiating elements 232 and the high-band radiating elements 242. Herein, a dipole arm of a radiating element that transmits RF energy in a first frequency band is considered to be “transparent” to RF energy in a second, different frequency band RF energy if the RF energy in the second frequency band poorly couples to the dipole arm. Accordingly, if a dipole arm of a first radiating element that is transparent to a second frequency band is positioned so that it overlaps a second radiating element that transmits in the second frequency band, the addition of the first radiating element will not materially impact the antenna pattern of the second radiating element.

Referring to FIGS. 3B and 3C, each dipole arm 330 includes a plurality of resonant circuit nodes 340 that are electrically connected to each other in series by a plurality of metal traces 360. In the depicted embodiment, each dipole arm 330 includes five resonant circuit nodes 340-1 through 340-5 that are interconnected by four metal traces 360-1 through 360-4. It will be appreciated, however, that more or fewer resonant circuit nodes 340 and/or metal traces 360 may be provided in other embodiments. Each dipole arm 330 is implemented in the metallization layer 326 that is on the front side of the dielectric substrate 324. Embodiments of the present invention, however, are not limited thereto. For example, in other embodiments, the metallization pattern 326 may be provided on both sides of the dielectric substrate 324 or some of the dipole arms 330 may be implemented on the front side of the dielectric substrate 324 and other of the dipole arms 330 may be implemented on the rear side of the dielectric substrate 324. In still other embodiments, part of one or more of the dipole arms 330 may be implemented on the front side of the dielectric substrate 324 and the remainder of the dipole arms 330 may be implemented on the rear side of the dielectric substrate 324.

Each dipole arm 330 may have the same design, with the first resonant circuit node 340-1 being the resonant circuit node 340 closest to the feed stalk 310, and the second through fifth resonant circuit nodes 340-2 through 340-5 positioned outwardly from the first resonant circuit node 340-1 in numerical order. FIGS. 3B-3C illustrate the constituent elements of each dipole arm 330. The elements are numbered on different of the dipole arms 330 to reduce the density of reference numbers in the figures. The first resonant circuit node 340-1 comprises a first inner metal patch 342-1, a first upper metal ring section 344-1, a first lower metal ring section 346-1, a first upper metal bridge 348-1 that physically and electrically connects the first inner metal patch 342-1 to the first upper metal ring section 344-1, and a first lower metal bridge 350-1 that physically and electrically connects the first inner metal patch 342-1 to the first lower metal ring section 346-1. A first upper gap 352-1 where no metallization is present separates the first inner metal patch 342-1 from the first upper metal ring section 344-1, and a first lower gap 354-1 where no metallization is present separates the first inner metal patch 342-1 from the first lower metal ring section 346-1. The first inner metal patch 342 is a circular patch in the depicted embodiment and the perimeter of the first inner metal patch 342 is fully filled with metal, although embodiments of the present invention are not limited thereto. The first upper metal ring section 344-1 and the first lower metal ring section 346-1 are each arcuate metal ring sections. The first upper metal ring section 344-1 and the first lower metal ring section 346-1 each comprises more than 25% of a circular ring and less than 50% of a circular ring and are positioned outside the first inner metal patch 342-1 so that they together surround most of the first inner metal patch 342-1. The second through fifth resonant circuit nodes 340-2 through 340-5 that are included in each dipole arm 330 may have the same general design as the first resonant circuit node 340-1, although the sizes and locations of the inner metal patches 342, the upper and lower metal ring sections 344, 346, and/or the upper and lower metal bridges 348, 350, may vary in different of the resonant circuit nodes 340, as will be discussed in more detail below.

The constituent components of the second through fifth resonant circuit nodes (i.e., the inner metal patches 342, the upper and lower metal ring sections 344, 346, the upper and lower metal bridges 348, 350, and the upper and lower gaps 352, 354) will be referred to in this Detailed Description individually using two part reference numerals with the constituent components of the second through fifth resonant circuit nodes 340-2 through 340-5 using two part reference numerals that end in -2, -3,- 4 and -5, respectively, to specifically identify the constituent components of the different resonant circuit nodes 340. It will be appreciated, however, that in the appended claims, references to a “first,” “second,” “third” (and the like), or constituent components thereof, may refer to any of the resonant circuit nodes, or constituent components thereof, as in the claims the terms “first,” “second,” “third” and the like are merely used to distinguish between different elements and are not intended to identify specific instances of those elements as shown in the specification. It will also be appreciated that the terms “upper” and “lower” that are used to describe the metal ring sections 344, 346 and the metal bridges 348, 350 are used to distinguish between the two metal ring sections 344, 346 and the two metal bridges 348, 350 of each resonant circuit node 340, but do not require a particular orientation, as the radiating element 300 may be rotated so that something that was originally on an upper side is then on a lower side. Thus, it will be appreciated that while all of the upper metal ring sections 344 and all of the upper metal bridges 348 of the resonant circuit nodes 340 of a given dipole arm 330 will extend in a first general direction, and that all of the lower metal ring sections 346 and all of the lower metal bridges 350 of the resonant circuit nodes 340 of the given dipole arm 330 will extend in a second general direction that is opposite the first general direction, the terms “upper” and “lower” do not require a particular orientation with respect to the horizontal plane.

The resonant circuit nodes 340 included in the first and second dipole arms 330-1, 330-2 extend along the first axis L_{A1} (FIG. 3A) that is defined by the first dipole radiator 320-1 and resonant circuit nodes 340 included in the third and fourth dipole arms 330-3, 330-4 extend along the second axis L_{A2} (FIG. 3A) that is defined by the second dipole radiator 320-2. A respective metal trace 360 physically and electrically connects each pair of adjacent resonant circuit nodes 340. Each metal trace 360 may have a length that is at least three times its width. In some embodiments, each metal trace 360 may have a length (where the length refers to the sum of the lengths of the metal trace sections forming the metal trace 360) that is at least five times, at least eight times, or at least ten times its width. In the depicted embodiment, each metal trace 360 is implemented as a meandered metal trace 360. Herein, a meandered metal trace refers to a non-linear conductive trace that follows a meandered path to increase the path length thereof. The meandered metal traces 360 may have extended lengths yet still have a small physical footprint.

The meandered metal traces 360 have high impedances and hence act like inductors. Moreover, each meandered metal trace 360 is implemented as a generally U-shaped metal trace 360. Capacitive coupling will occur across the gap 362 that separates the long sides of each U-shaped metal trace 360. Thus, each meandered metal trace 360 may be viewed as a parallel inductor-capacitor (“LC”) resonant circuit. As shown in FIGS. 3B-3C, the U-shaped metal traces 360 that are included in each dipole arm 330 may extend away from the axis L_{A1} (or L_{A2}) that is defined by the alignment of the resonant circuit nodes 340 of the respective dipole arms 330. In the depicted embodiment, some of the U-shaped metal traces 360 extend away from the first or second axis L_{A1}, L_{A2} in a first direction and the remainder of the U-shaped metal traces 360 extend away from the first or second axis L_{A1}, L_{A2} in a second direction that is opposite the first direction. In the depicted embodiment, adjacent U-shaped metal traces 360 extend away from the first or second axis L_{A1}, L_{A2} in opposed directions.

An input trace 370 connects the first resonant circuit node 340-1 to one of the feed stalks 310-1, 310-2. The input trace 370 may be wider than the meandered metal traces 360. The input trace 370, the resonant circuit nodes 340 and the meandered metal traces 360 of each dipole arm 330 form a continuous electrical path that extends from a base of the dipole arm 330 to a distal end thereof.

As discussed above, the low-band radiating elements 300 may be cloaked over at least a portion of the mid-band operating frequency band and at least a portion of the high-band operating frequency band in some embodiments. For example, the low-band radiating elements 300 may be cloaked over the 1695-2690 MHz frequency range and over the 3.3-4.0 GHz frequency range. It generally is very challenging to design a low-band radiating element that provides good transmission performance in the low-band operating frequency band while also exhibiting good cloaking performance over a wide range of frequencies, some of which are close to frequencies within the low-band operating frequency band. One of the difficulties in designing such a radiating element is that it is difficult to achieve wide-band cloaking while also maintaining a good impedance match between the dipole arms and the feed stalks. If the impedance match is poor, then the operating bandwidth of the low-band radiating element may not cover the entire low-band operating frequency range (or a desired sub-portion thereof). The dipole arms 330 of the radiating elements according to embodiments of the present invention include additional frequency-dependent resonating structures that allow the dipole arms to have a good impedance match over the full 696-960 MHz portion of the low-band operating frequency band while also exhibiting excellent cloaking performance over both the 1695-2690 MHz and 3.3-4.0 GHz frequency ranges.

Referring again to FIGS. 3B-3C, it can be seen that the five inner conductive patches 342-1 through 342-5 of each dipole arm 330 do not all have the same diameter, and hence have different perimeters. In particular, the inner conductive patches 342 of the resonant circuit nodes 340 get increasingly smaller the farther the resonant node 340 is from the center of the radiating element 300 (and hence the farther the resonant node 340 is from the feed point for the dipole arm 330). In the depicted embodiment, the diameter of each inner conductive patch 342 of each resonant circuit node 340 is about 6-13% smaller than the diameter of an adjacent inner conductive patch 342 of the resonant circuit node 340 that is closer to the base of the dipole arm 330. The larger the inner conductive patch 342, the greater the capacitive coupling between the inner conductive patch 342 and the upper and lower metal ring sections 344, 346 that substantially surround the inner conductive patch 342. The variations in the diameters of the inner conductive patches 342 vary the capacitance of the different resonant circuit nodes 340, which may substantially improve the cloaking performance of radiating element 300, allowing the radiating element 300 to exhibit excellent cloaking performance over both the 1695-2690 MHz and 3.3-4.0 GHz frequency ranges. In particular, the smaller diameter inner conductive patches 342 may improve the cloaking performance at higher frequencies while the larger diameter inner conductive patches 342 may improve the cloaking performance at lower frequencies.

As can best be seen in the enlarged view of FIG. 3C, the upper metal bridges 348 of different resonant circuit nodes 340 may extend away from their respective associated inner conductive patches 342 at different angles. For example, in the depicted embodiment, the upper and lower metal bridges 348-2 through 348-5 and 350-2 through 350-5 of resonant circuit nodes 340-2 through 340-5 extend away from the respective inner conductive patches 342-2 through 342-5 at angles of about 0° and about 180°, respectively, when the dipole arms 330 are oriented as shown in FIG. 3C (here it is assumed that an axis bisecting the dipole arm in the vertical direction extends at an angle of 0°). In contrast, the upper and lower metal bridges 348-1, 350-1 of resonant circuit node 340-1 extend away from the inner conductive patch 342-1 thereof at angles of about 10° and about 200°. Having the upper and lower metal bridges 348-1, 350-1 of resonant circuit node 340-1 extend away from the inner conductive patch 342-1 thereof at different angles than the upper and lower metal bridges 348, 350 of other of the resonant circuit nodes 340 helps improve the impedance match between each dipole arm 330 and the feed stalk 310. Having the upper and lower metal bridges 348, 350 of different resonant circuit nodes 340 extend at different radial angles may also help improve the cloaking performance of radiating element 300.

The range of angles sub-tended by the upper metal ring sections 344 and/or the lower metal ring sections 346 may also differ in different of the resonant circuit nodes 340. For example, the outer diameter of the upper metal ring sections 344-2 through 344-5 of the second through fifth resonant circuit nodes 340-2 through 340-5 extends along an arc of about −74° to 74°, while the outer diameter of the lower metal ring sections 346-2 through 346-5 of the second through fifth resonant circuit nodes 340-2 through 340-5 each extend along an arc of about 106° to −106°. In contrast, the outer diameter of the first upper metal ring section 344-1 of the first resonant circuit node 340-1 extends along an arc of about −74° to 84°, while the outer diameter of the first lower metal ring section 346-1 of the first resonant circuit node 340-1 extends along an arc of about 134° to −106°. Thus, it can be seen that the angular extent of the upper and lower metal ring sections 344, 346 of different resonant circuit nodes 340 (where the angular extent refers to the length of the arcuate metal ring sections 344, 346 along the outer diameter thereof) may be different, as may be the range of angles subtended by the different upper and lower metal ring sections 344, 346. By configuring the upper and lower metal ring sections 344, 346 differently in different resonant circuit nodes 340 it is possible to improve both the impedance match and the cloaking performance of radiating element 300.

FIG. 3D is a circuit diagram illustrating the equivalent circuit of each of the dipole arms 330. As shown in FIG. 3D, each resonant circuit node 340 may be modelled as a parallel LC circuit having a respective inductance L1-L5 and a respective capacitance C1-C5. For the three inner resonant circuit nodes 340-2 through 340-4, the inductances L2-L4correspond to the inductances of the conductive path that extends through the center of the respective resonant circuit node 340, which comprises the inner conductive patch 342 and a pair of short narrow metal traces 356, 358 that connect the inner conductive patch 342 to the meandered conductive trace(s) 360 that connect to each resonant circuit node 340. The value of inductances L2-L4 may the similar for each of the three inner resonant circuit nodes 340-2 through 340-4, but will not be identical because the sizes of the inner conductive patches 342-2 through 342-4 differ. The first and fifth resonant circuit nodes 340-1 and 340-5 will have smaller inductance values L1 and L5, respectively, due to the wider metal trace section 356-1 in resonant circuit node 340-1 and the omission of any metal trace 358 in resonant circuit node 340-5. The values of capacitances C1-C5 differ since the gaps 352, 354 included in the resonant circuit nodes 340 become larger as the distance of the resonant circuit node 340 from the base of the dipole arm 330 increases. As is also shown in FIG. 3D, each meandered metal trace 360 also forms a parallel LC resonant circuit. In the depicted embodiment, each parallel LC resonant circuit formed by the meandered metal traces 360 has the same inductance value L6 and the same capacitance value C6, although it will be appreciated that embodiments of the present invention are not limited thereto. The parallel LC circuits formed by resonant circuit nodes 340-3 and 340-4 and the parallel LC resonant circuit formed by meandered metal traces 360 are electrically connected in series.

The five resonant circuit nodes 340-1 through 340-5 and the four meandered metal traces 360-1 through 360-4 that are included in each dipole arm 330 thus form nine parallel LC circuits that are electrically connected to each other in series. Since the resonant circuit nodes 340 have different capacitance and inductance values, the response of the dipole arm 330 may be tuned to obtain cloaking over a wide frequency range.

Each dipole arm 330 has a length of 174 mm, which is compact for a low-band radiating element. In addition, each dipole arm 330 may be formed on a printed circuit board that includes a single metallization layer, which reduces costs. Sheet metal on plastic dipole arms may also be used, which may reduce costs further. Radiating element 300 also exhibits excellent cloaking performance, across both the full 1695-2690 MHz and the full 3.3-4.0 GHz frequency ranges. In fact, the cloaking performance is excellent across the full 1.7-5.0 GHz frequency range, as low-band radiating element 300 is essentially invisible to RF over that full frequency range. Simulations also show that radiating element 300 has excellent cross-polarization performance and pattern shapes in the low-band frequency range, and very low sidelobe levels.

Referring to FIGS. 2 and 3A-3C, pursuant to some embodiments of the present invention, antennas are provided that comprise a reflector 210, a first radiating element 222 (300) that extends forwardly from the reflector 210, where the first radiating element 222 is configured to operate in a first operating frequency band (here, the low-band operating frequency band), and a second radiating element 232 extending forwardly from the reflector 210 that is configured to operate in a second operating frequency band (here the mid-band operating frequency band) that encompasses higher frequencies than the first operating frequency band. The first radiating element 300 includes first and second dipole radiators 320-1, 320-3, where the first dipole radiator 320-1 includes a first dipole arm 330-1 and a second dipole arm 330-2 and the second dipole radiator includes a third dipole arm 330-1 and a fourth dipole arm 340-4. The first dipole arm 330-1 comprises two resonant circuits 340 that each include an inner metal patch 342 and an upper ring section 344 that at least partially surrounds the respective inner metal patches 342. Moreover, a perimeter of the inner metal patch 342 of the first of the two resonant circuits 340 is greater than a perimeter of the inner metal patch 342 of the second of the two resonant circuits 340.

The two resonant circuits 340 may be part a larger set of resonant circuits 340. The two resonant circuits 340 may each be a parallel LC circuit. All of the resonant circuits 340 in the larger set of resonant circuits may be electrically connected to each other in series. The first of the two resonant circuits 340 may be the resonant circuit 340 in the larger set of resonant circuits 340 that is closest to the second dipole arm 330-2. The second of the resonant circuits 340 may, for example, be the one of the larger set of resonant circuits 340 that is farthest from the second dipole arm 330-2.

Each of the resonant circuits 340 may be physically and electrically connected to at least one other of the resonant circuits 340 by a respective meandered metal trace 360. The first dipole arm 330-1 may extend along a longitudinal axis L_{A1}, and a first of the meandered metal traces 360 may extend to a first side of the longitudinal axis L_{A1}, and a second of the meandered metal traces 360 may extend to a second side of the longitudinal axis L_{A1} that is opposite the first side. A third of the meandered metal traces 360 may also extend to the first side of the longitudinal axis L_{A1}, and the second of the meandered metal traces 360 may be in between the first and third of the meandered metal traces 360. The resonant circuits 340 and the meandered metal traces 360 may all be implemented in a single metal layer 326 of a printed circuit board 322.

The first of the resonant circuits 340 may further comprise a lower metal ring section 346 that at least partially surrounds the inner metal patch 342 of the first of the resonant circuits 340. The upper and lower metal ring sections 344, 346 may, for example, each surround at least 25% and less than 50% of the perimeter of the inner metal patch 342. The second of the resonant circuits 340 may similarly include a lower metal ring section 346 that at least partially surrounds its inner metal patch 342. The inner metal patches 342 of the first and second of the resonant circuits 340 may each have circular perimeters and the upper and lower metal ring sections 344, 346 may each be arcuate metal ring sections. It will be appreciated, however, that in other embodiments, the inner metal patches 342 and/or the upper and lower metal ring sections 344, 346 may have other shapes such as, for example, rectangular and/or rectangular ring section shapes.

The upper metal ring section 344 of the first of the resonant circuits 340 is physically and electrically connected to its associated inner metal patch 342 by an upper metal bridge 348 that extends from the inner metal patch 342 to the upper metal ring section 344, and the upper metal ring section 344 of the first of the resonant circuits 340 is similarly physically and electrically connected to the inner metal patch 342 of the second of the resonant circuits 340 by an upper metal bridge 348. Likewise, the lower metal ring section 346 of the first of the resonant circuits 340 is physically and electrically connected to its associated inner metal patch 342 by a lower metal bridge 350, and the lower metal ring section 346 of the second of the resonant circuits 340 is similarly physically and electrically connected to its inner metal patch 342 by a lower metal bridge 350.

The upper and lower metal bridges 348, 350 included in the first of the resonant circuits 340 may extend radially from the inner metal patch 342 thereof at respective first and second angles, and the upper and lower metal bridges 348, 350 included in the second of the resonant circuits 340 may extend radially from the inner metal patch 342 thereof at respective third and fourth angles, where the first angle is different than both the third angle and the fourth angle. The second angle may also different than both the third angle and the fourth angle.

The antenna 200 may further comprise a third radiating element 242 that extends forwardly from the reflector 210 and that is configured to operate in a third operating frequency band that encompasses higher frequencies than the second operating frequency band. The first and second dipole arms 330-1, 330-2 may be configured to be substantially transparent to RF signals in the second and/or third operating frequency bands.

Pursuant to further embodiments of the present invention, base station antennas such as base station antenna 200 are provided that comprise a reflector 210, a first radiating element 222 (300) that extends forwardly from the reflector 210, where the first radiating element 222 (300) is configured to operate in a first operating frequency band (here, the low-band operating frequency band), and a second radiating element 232 that extends forwardly from the reflector 210 that is configured to operate in a second operating frequency band (here the mid-band operating frequency band) that encompasses higher frequencies than the first operating frequency band. The first radiating element 222 (300) includes a first dipole radiator 320-1 having a first dipole arm 330-1 and a second dipole arm 330-2 and a second dipole radiator 320-2 having a third dipole arm 330-3 and a fourth dipole arm 330-4. The first dipole arm 330-1 comprises a first resonant circuit 340-1 that includes a first inner metal patch 342-1, a first upper metal ring section 344-1 and a first lower metal ring section 346-1 that each partially surround the first inner metal patch 342-1, and a first upper metal bridge 348-1 and a first lower metal bridge 350-1 that extend radially from the first inner metal patch 342-1 to the respective first upper and lower metal ring sections 344-1, 346-1 at respective first and second angles. The first dipole arm 330-1 further comprises a second resonant circuit 340-2 that includes a second inner metal patch 342-2, a second upper metal ring section 344-2 and a second lower metal ring section 346-2 that each partially surround the second inner metal patch 342-2, and a second metal bridge 348-2 and a second lower metal bridge 350-2 that extend radially from the second inner metal patch 342-2 to the respective second upper and lower metal ring sections 344-2, 346-2 at respective third and fourth angles. The first angle may be different than both the third angle and the fourth angle and the second angle may also be different than both the third angle and the fourth angle.

Pursuant to still further embodiments of the present invention, base station antennas such as base station antenna 200 are provided that comprise a reflector 210, a first radiating element 222 (300) that extends forwardly from the reflector 210, where the first radiating element 222 (300) is configured to operate in a first operating frequency band (here, the low-band operating frequency band), and a second radiating element 232 extending forwardly from the reflector 210 that is configured to operate in a second operating frequency band (here the mid-band operating frequency band) that encompasses higher frequencies than the first operating frequency band. The first radiating element 222 (300) includes a first dipole radiator 320-1 having a first dipole arm 330-1 and a second dipole arm 330-2 and a second dipole radiator 320-2 having a third dipole arm 330-3 and a fourth dipole arm 330-4. The first dipole arm 330-1 comprises a plurality of parallel inductor-capacitor (“LC”) resonant circuits 340 that are electrically connected to each other in series by a plurality of meandered metal traces 360, where each resonant circuit 340 in the plurality of parallel LC resonant circuits 340 comprises an inner metal patch 342 and at least one metal ring section 344, 346 that at least partially surrounds the respective inner metal patch 342.

Pursuant to additional embodiments of the present invention, base station antennas such as base station antenna 200 are provided that comprise a reflector 210, a first radiating element 222 (300) that extends forwardly from the reflector 210, where the first radiating element 222 (300) is configured to operate in a first operating frequency band (here, the low-band operating frequency band), and a second radiating element 232 extending forwardly from the reflector 210 that is configured to operate in a second operating frequency band (here the mid-band operating frequency band) that encompasses higher frequencies than the first operating frequency band. The first radiating element 222 (300) includes a first dipole radiator 320-1 having a first dipole arm 330-1 and a second dipole arm 330-2 and a second dipole radiator 320-2 having a third dipole arm 330-3 and a fourth dipole arm 330-4. The first dipole arm 330-1 comprises a first resonant circuit 340-1 that includes a first inner metal patch 342-1 and first upper and lower metal ring sections 344-1, 346-1 that are on opposed sides of the first inner metal patch 342-1 and that partially surround the first inner metal patch 342-1. The second dipole arm 330-2 comprises a second resonant circuit 340-2 that includes a second inner metal patch 342-2 and second upper and lower metal ring sections 344-2, 346-2 that are on opposed sides of the second inner metal patch 342-2 and that partially surround the second inner metal patch 342-2. A first length of the first upper metal ring section 344-1 is different than a third length of the second upper metal ring section 344-2 and a fourth length of the second lower metal ring section 346-2. Additionally, a second length of the first lower metal ring section 346-1 may also be different than both the third length and the fourth length.

FIG. 4 is a front view of a low-band radiating element 400 according to further embodiments of the present invention. As can be seen by comparing FIGS. 3B and 4, low-band radiating elements 300 and 400 have similar designs, with the primary difference being that low-band radiating element 400 has dipole arms 430 that are each formed as a closed loop. Each dipole arm 430 includes ten resonant circuit nodes 440 that are interconnected by nine meandered metal traces 460. Two additional meandered metal traces 460 connect the innermost resonant circuit nodes 440-1 and 440-10 to a feed stalk 410 of the radiating element 400 (only four small forwardly tabs of the feed stalk 410 are visible in the view of FIG. 4). Each dipole arm 430 may have a generally oval shape. All four dipole arms 430-1 through 430-4 may have the same design.

Radiating element 400 of FIG. 4 may have a smaller “footprint” than radiating element 300. Herein, the “footprint of a radiating element refers to the area of the smallest square that will enclose the radiating element when viewed from the front. Since the dipole arms 430 are implemented as loops in radiating element 400, the RF currents flow along curved paths which acts to increase the electrical length of the dipole arm 430 for a given physical length, and hence the dipole arms 430 can be shortened (physically) as compared to the straight dipole arms 330 of radiating element 300.

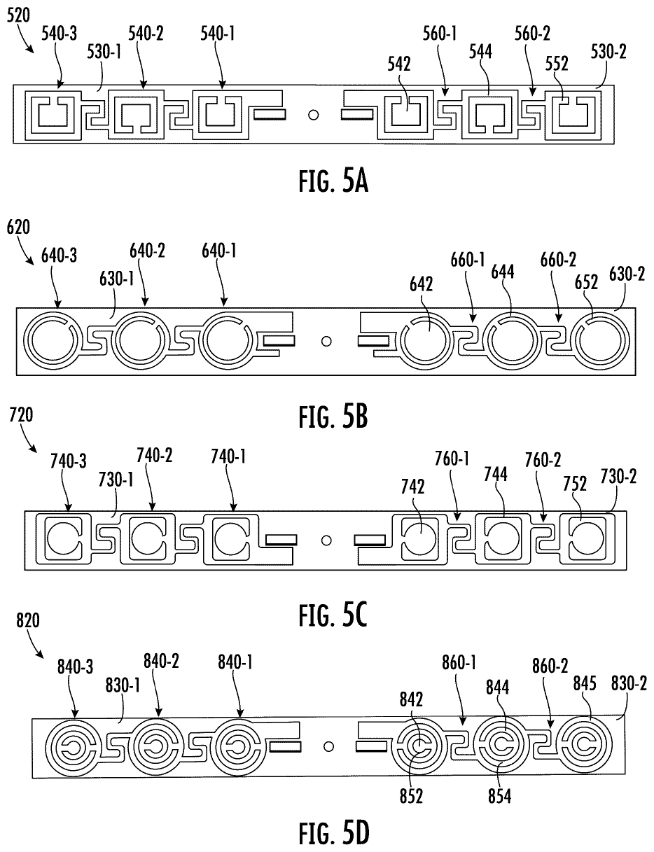

FIGS. 3A-3C and 4 illustrate two example radiating elements 300, 400 according to embodiments of the present invention. It will be appreciated, however, that the radiating elements according to embodiments of the present invention may have many different designs. For example, FIGS. 5A-5D illustrate dipole radiators of four additional radiating elements according to embodiments of the present invention. It will be appreciated that for each of FIGS. 5A-5D that two of the depicted dipole radiators may be provided and mounted on a feed stalk in a cross configuration to in each case provide a cross-dipole radiating element according to further embodiments of the present invention.

FIG. 5A illustrates a dipole radiator 520 that comprises first and second center-fed dipole arms 530-1, 530-2. Each dipole arm 530 comprises three resonant circuit nodes 540-1 through 540-3 that are interconnected by first and second meandered metal traces 560-1, 560-2. Each resonant circuit node 540 comprises a rectangular inner metal patch 542 and a rectangular metal ring section 544 that comprises a full ring so that it completely surrounds the inner metal patch 542. The inner metal patch 542 is separated from the metal ring section 544 by a gap 552 where no metal is provided. The width of each gap 552 is constant. Each resonant circuit node 540 may act like a split ring resonator. The meandered metal traces 560 will also act as resonant circuits as discussed above with reference to radiating element 300.

FIG. 5B illustrates a dipole radiator 620 that comprises first and second center-fed dipole arms 630-1, 630-2. Each dipole arm 630 comprises three resonant circuit nodes 640-1 through 640-3 that are interconnected by first and second meandered metal traces 660-1, 660-2. Each resonant circuit node 640 comprises a circular inner metal patch 642 and a circular metal ring section 644 that surrounds the inner metal patch 642. The inner metal patch 642 is separated from the metal ring section 644 by a gap 652 where no metal is provided. The width of each gap 652 is constant. Each resonant circuit node 640 may act like a split ring resonator. The meandered metal traces 660 will also act as resonant circuits as discussed above with reference to radiating element 300. The width of each gap 652 is smaller than the widths of the gaps 552 in the resonant circuit nodes 540 of dipole radiator 520. This increases the capacitance levels and may potentially improve the cloaking performance.

FIG. 5C illustrates a dipole radiator 720 that comprises first and second center-fed dipole arms 730-1, 730-2. Each dipole arm 730 comprises three resonant circuit nodes 740-1 through 740-3 that are interconnected by first and second meandered metal traces 760-1, 760-2. Each resonant circuit node 740 comprises a circular inner metal patch 742 and a rectangular metal ring section 744 that surrounds the inner metal patch 742. The inner metal patch 742 is separated from the metal ring section 744 by a gap 752 where no metal is provided. Each resonant circuit node 740 may act like a split ring resonator. The meandered metal traces 760 will also act as resonant circuits as discussed above with reference to radiating element 300. Dipole radiator 720 of FIG. 5C differs from dipole radiator 520 of FIG. 5A in that the rectangular inner metal patches 542 of dipole radiator 520 are replaced in dipole radiator 720 with circular inner metal patches 742 so that the gaps 752 no longer have a constant width. This changes the capacitance level and may potentially improve the cloaking performance.

FIG. 5D illustrates a dipole radiator 820 that comprises first and second center-fed dipole arms 830-1, 830-2. Each dipole arm 830 comprises three resonant circuit nodes 840-1 through 840-3 that are interconnected by first and second meandered metal traces 860-1, 860-2. Each resonant circuit node 840 comprises a circular inner metal patch 842, a first circular ring section 844 that surrounds the inner metal patch 842, and a second circular ring section 845 that surrounds the first circular ring section 844. The inner metal patch 842 is separated from the first metal ring section 844 by a first gap 852 and the first metal ring section 844 is separated from the second metal ring section 845 by a second gap 854. Each resonant circuit node 840 may act like a pair of split ring resonators. The meandered metal traces 860 will also act as resonant circuits as discussed above with reference to radiating element 300.

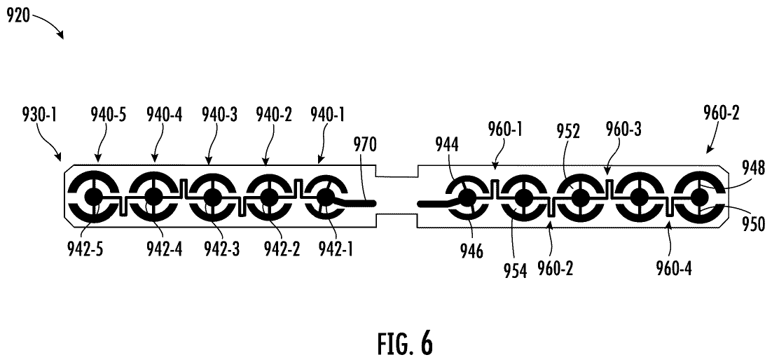

As discussed above, in low-band radiating element 300, each dipole arm 330 has resonant circuit nodes 340-1 through 340-5 that have respective inner metal patches 342-1 through 342-5 that have decreasing diameters as the resonant circuit nodes 340 are spaced farther from the feed point at the base of the dipole arm 330. As a result, the capacitance value of each parallel LC circuit formed by the respective resonant circuit nodes 340-1 through 340-5 decreases as the resonant circuit nodes 340-1 through 340-5 are spaced farther from the feed point at the base of the dipole arm 330. FIG. 6 illustrates a dipole radiator 920 that comprises first and second center-fed dipole arms 930-1, 930-2 which achieves the same varied capacitance response in a different way.

As shown in FIG. 6, each dipole arm 930 includes five resonant circuit nodes 940-1 through 940-5 that are electrically connected to each other in series by four meandered metal traces 960-1 through 960-4. The meandered metal traces 960-1 through 960-4 may be identical to meandered metal traces 360-1 through 360-4 of dipole arm 330 so further description thereof will be omitted here. The resonant circuit nodes 940-1 through 940-5 are similar to resonant circuit nodes 340-1 through 340-5. In particular, each resonant circuit node 940 includes an inner metal patch 942, an upper metal ring section 944, a lower metal ring section 946, an upper metal bridge 948, and a lower metal bridge 950. An upper gap 952 separates each inner metal patch 942 from an associated upper metal ring section 944, and a lower gap 954 separates each inner metal patch 942 from an associated lower metal ring section 946. An input trace 970 that may be identical to input trace 370 connects the first resonant circuit node 940-1 to a feed stalk (not shown).

The dipole arms 930 differ from the dipole arms 330 of FIGS. 3A-3C in that all of the inner metal patches 942-1 through 942-5 have the same diameter (instead of different diameters, as is the case in each dipole arm 330), but the widths of the gaps 952, 954 are different in each of the resonant circuit nodes 940-1 through 940-5, with the width increasing as the resonant circuit nodes 940-1 through 940-5 are spaced farther from the feed point at the base of the dipole arm 930. The widths of the gaps 952, 954 increase because the diameters of the arcuate metal ring sections 944, 946 of the resonant circuit nodes 940 increase as the positions of the resonant circuit nodes 940 move outwardly. The variable widths of the gaps 952, 954 thus provides the varied capacitance for resonant circuit nodes 940-1 through 940-5. As dipole arms 930 may otherwise be identical to dipole arms 330, further description thereof will be omitted herein.

While the dipole arms of the low-band radiating elements described above are implemented on one or more dipole radiator printed circuit boards, it will be appreciated that embodiments of the present invention are not limited thereto. For example, in other embodiments, any of the above-described radiating elements may be implemented using sheet metal dipole arms that are mounted on a dielectric support or using metallized plastic.

While the example embodiments described above have low-band radiating elements that are designed to be transparent to RF energy radiated in two higher frequency bands, it will be appreciated that embodiments of the present invention are not limited thereto. For example, in other embodiments, mid-band radiating elements may be provided that have first dipole arms that are configured to be substantially transparent to RF energy in a lower frequency band and second dipole arms that are configured to be substantially transparent to RF energy in a higher frequency band.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. An antenna, comprising:
a reflector;
a first radiating element extending forwardly from the reflector, the first radiating element configured to operate in a first operating frequency band; and
a second radiating element extending forwardly from the reflector, the second radiating element configured to operate in a second operating frequency band that encompasses higher frequencies than the first operating frequency band,
wherein the first radiating element includes a first dipole radiator having a first dipole arm and a second dipole arm and a second dipole radiator having a third dipole arm and a fourth dipole arm, and
wherein the first dipole arm comprises a first resonant circuit that includes a first inner metal patch and a first upper metal ring section that at least partially surrounds the first inner metal patch and a second resonant circuit that includes a second inner metal patch and a second upper metal ring section that at least partially surrounds the second inner metal patch, and
wherein a perimeter of the first inner metal patch is greater than a perimeter of the second inner metal patch.

2. The antenna of claim 1, wherein the first resonant circuit and the second resonant circuit are a first of the resonant circuits and a second of the resonant circuits, respectively, of a plurality of resonant circuits.

3. The antenna of claim 2, wherein the resonant circuits in the plurality of resonant circuits are electrically connected to each other in series.

4. The antenna of claim 3, wherein the first of the resonant circuits is the one of the plurality of resonant circuits that is closest to the second dipole arm.

5. The antenna of claim 4, wherein the second of the resonant circuits is the one of the plurality of resonant circuits that is farthest from the second dipole arm.

6. The antenna of claim 3, wherein the first of the resonant circuits is physically and electrically connected to a third of the resonant circuits by a first meandered metal trace.

7. The antenna of claim 6, wherein the second of the resonant circuit is physically and electrically connected to a fourth of the resonant circuits by a second meandered metal trace.

8-23. (canceled)

24. An antenna, comprising:
a reflector;
a first radiating element extending forwardly from the reflector, the first radiating element configured to operate in a first operating frequency band; and
a second radiating element extending forwardly from the reflector, the second radiating element configured to operate in a second operating frequency band that encompasses higher frequencies than the first operating frequency band;
wherein the first radiating element includes a first dipole radiator having a first dipole arm and a second dipole arm and a second dipole radiator having a third dipole arm and a fourth dipole arm,
wherein the first dipole arm comprises a first resonant circuit that includes a first inner metal patch, a first upper metal ring section and a first lower metal ring section that each partially surround the first inner metal patch, and a first upper metal bridge and a first lower metal bridge that extend radially from the first inner metal patch to the first upper metal ring section and the first lower metal ring section at respective first and second angles, and
wherein the first dipole arm comprises a second resonant circuit that includes a second inner metal patch, a second upper metal ring section and a second lower metal ring section that each partially surround the second inner metal patch, and a second upper metal bridge and a second lower metal bridge that extend radially from the second inner metal patch to the second upper metal ring section and the second lower metal ring section, respectively, at respective third and fourth angles,
where the first angle is different than both the third angle and the fourth angle.

25. The antenna of claim 24, wherein the second angle is also different than both the third angle and the fourth angle.

26. The antenna of claim 24, wherein the first upper metal ring section and the first lower metal ring section each surround at least 25% and less than 50% of the perimeter of the first inner metal patch.

27. The antenna of claim 24, wherein a perimeter of the first inner metal patch is greater than a perimeter of the second inner metal patch.

28-37. (canceled)

38. The antenna of claim 24, wherein the first inner metal patch and the second inner metal patch have circular perimeters and the first and second upper metal ring sections are arcuate metal ring sections.

39-40. (canceled)

41. The antenna of claim 24, further comprising a third radiating element extending forwardly from the reflector that is configured to operate in a third operating frequency band that encompasses higher frequencies than the second operating frequency band, wherein the first and second dipole arms are configured to be substantially transparent to RF signals in both the second and third operating frequency bands.

42. An antenna, comprising:
a reflector;
a first radiating element extending forwardly from the reflector, the first radiating element configured to operate in a first operating frequency band; and
a second radiating element extending forwardly from the reflector, the second radiating element configured to operate in a second operating frequency band that encompasses higher frequencies than the first operating frequency band;
wherein the first radiating element includes a first dipole radiator having a first dipole arm and a second dipole arm and a second dipole radiator having a third dipole arm and a fourth dipole arm, and
wherein the first dipole arm comprises a plurality of parallel inductor-capacitor (“LC”) resonant circuits that are electrically connected to each other in series by a plurality of meandered metal traces, where each resonant circuit in the plurality of parallel LC resonant circuits comprises an inner metal patch and at least one metal ring section that at least partially surrounds the respective inner metal patch.

43. The antenna of claim 42, wherein the first dipole arm extends along a longitudinal axis, and a first of the meandered metal traces extends to a first side of the longitudinal axis, and a second of the meandered metal traces extends to a second side of the longitudinal axis that is opposite the first side.

44. The antenna of claim 43, wherein a third of the meandered metal traces extends to the first side of the longitudinal axis, and the second of the meandered metal traces is in between the first and third of the meandered metal traces.

45. The antenna of claim 42, wherein a first perimeter of the inner metal patch of a first of the parallel LC resonant circuits is greater than a second perimeter of the inner metal patch of a second of the parallel LC resonant circuits.

46. The antenna of claim 45, wherein the first of the parallel LC resonant circuits is the one of the plurality of parallel LC resonant circuits that is closest to the second dipole arm.

47. The antenna of claim 46, wherein the second of the parallel LC resonant circuits is the one of the plurality of parallel LC resonant circuits that is farthest from the second dipole arm.

48. The antenna of claim 42, wherein the at least one metal ring section included in each of plurality of parallel LC resonant circuits comprises an upper metal ring section and a lower metal ring section that together surrounds at least 70% of a perimeter of the inner metal patch of the respective one of the parallel LC resonant circuits.

49-66. (canceled)
